(19) United States
(12) Patent Application Publication
(10) Pub. No.: US 2010/0094543 A1
(43) Pub. Date: Apr. 15, 2010

(54) Systems And Methods For Providing Geography-Based Tours

(75) Inventors: Robert H. Friedenthal, Encino, CA (US); David G. Thompson, West Hollywood, CA (US); Savalas O. Colbert, Beverly Hills, CA (US)

Correspondence Address: SHEPPARD, MULLIN, RICHTER & HAMPTON LLP, 990 Marsh Road, Menlo Park, CA, 94025, US

(73) Assignee: 411 WEB DIRECTORY, Culver City, CA (US)

(21) Appl. No.: 12/351,782

(22) Filed: Jan. 9, 2009

Related U.S. Application Data
(60) Provisional application No. 61/104,236, filed on Oct. 9, 2008.
(60) Provisional application No. 61/110,551, filed on Nov. 1, 2008.

(51) Int. Cl. G01C 21/00; G06F 17/30

(52) U.S. Cl. 701/202; 707/E17.014; 707/E17.044; 707/E17.018

(57) ABSTRACT

Systems and methods for providing tours are described. In various embodiments, a method comprises receiving a tour request comprising location information, a first activity type, and a second activity type from a user, retrieving tour information from a tour database based on the location information, the first activity type, and the second activity type, the tour information comprising a first facility associated with the first activity type and a second facility associated with the second activity type, determining directions between the first facility and the second facility, and providing the directions and at least some tour information to the user.

### PRIORITY CLAIM

This application claims benefit of US provisional application Ser. No. 61/104,236, entitled “Real-Time Data Dynamically Generated and Communicated Over Network Devices in Relation to Geographical Location to Create a Societal Network,” filed on Oct. 9, 2008, and U.S. provisional application Ser. No. 61/110,551, entitled “Systems and Methods for Providing Geography-Based Tours,” filed on Nov. 1, 2008, both of which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to data retrieval over a network, and more particularly to the generation and delivery of geography-based tours.

### BACKGROUND

As the Internet becomes increasingly available, people have rely upon web sites to find and plan various activities. By accessing websites, people can find available products and services of which they were previously unaware. As a result, searching the Internet for local businesses and activities has become increasingly common.

In order to search the Internet for local businesses and activities, a search engine is often used. Unfortunately, many search engines either do not allow for searching for local services and products or the search is imprecise. As a result, people are forced sort through lists of businesses, services, and activities that are unavailable or unaccessible in order to find what they are looking for.

Further, although searching the Internet for a known business, service, or product is fairly simple, it is difficult for a person to search for a variety of local businesses, services, or products. Most search engines produce a wide variety of results that are inapplicable to the searcher's interests. Some websites, such as Yelp, have been developed to help people find a single business. In one example, a searcher inputs a type of food and a zip code to receive a list of restaurants that serve that food in or near that zip code. However, these websites do not help a searcher who wishes to find multiple businesses, services, and activities without the searcher making many individual searches. Further, each search result is unrelated to any previous search result. As a result, if the searcher wishes to visit multiple businesses, the searcher will be required to make several individual searches, determine directions between each stop, and figure out the trip on their own.

### SUMMARY

Systems and methods for providing tours are described. In various embodiments, a method comprises receiving a tour request comprising location information, a first activity type, and a second activity type from a user, retrieving tour information from a tour database based on the location information, the first activity type, and the second activity type, the tour information comprising a first facility associated with the first activity type and a second facility associated with the second activity type, determining directions between the first facility and the second facility, and providing the directions to the user.

In some embodiments, the first activity type comprises a food type, the second activity type comprises a theatrical production, the location information comprises the location of the user, the tour information comprises a name of a restaurant associated with the food type and a name of a theater associated with the theatrical event, and the directions are between the restaurant and the theater. The directions may also comprise directions from the user to the first facility. The method may further comprise generating a map showing a first location of the first facility and a second location of the second facility.

Further, retrieving tour information may further comprise retrieving user preferences from a user account associated with the user, retrieving a list of facilities associated with the first activity type, and selecting at least one first facility from the list of facilities based on the user preferences.

In some embodiments, retrieving tour information further comprises retrieving a list of facilities associated with the first activity type, retrieving at least one review of at least one first facility of the list of facilities, and selecting at least one first facility from the list of facilities based on the at least one review. Also, retrieving tour information may further comprise sorting the list of facilities based on the at least one review. Providing the directions to the user may comprise providing at least some of the sorted list of facilities including the selected at least one first facility to the user.

In various embodiments, retrieving tour information further comprises retrieving a list of facilities associated with the first activity type, determining a first distance between the user and a first facility of the list of facilities and a second distance between the user and a second facility of the list of facilities, determining a shortest distance based on a comparison of the first distance to the second distance, and selecting at least one facility from the list of facilities based on the shortest distance.

Further, retrieving tour information further may comprise retrieving a first list of facilities associated with the first activity type, selecting a first facility from the first list of facilities, retrieving a second list of facilities associated with the second activity type, determining a distance between the first facility and at least one second facility from the second list of facilities, and selecting the second facility from the second list of facilities based on the distance determination.

In various embodiments, a system comprises a tour module, a directions module, and a communication module. The tour module is configured to retrieve tour information from a tour database based on location information, a first activity type, and a second activity type, the tour information comprising a first facility associated with the first activity type and a second facility associated with the second activity type. The directions module is configured to determine directions between the first facility and the second facility. The communication module is configured to receive a tour request comprising the location information, the first activity type, and the second activity type from a user and to provide the directions between the first facility and the second facility to the user.

In some embodiments a computer readable medium comprises instructions. The instructions are executable by a processor for performing a method. The method may comprise receiving a tour request comprising location information, a first activity type, and a second activity type from a user, retrieving tour information from a tour database based on the location information, the first activity type, and the second activity type, the tour information comprising a first facility associated with the first activity type and a second facility associated with the second activity type, determining directions between the first facility and the second facility, and providing the directions to the user.

### BRIEF DESCRIPTION OF THE DRAWINGS

FIG. 1 is a block diagram of a network in accordance with some embodiments.

FIG. 2 is a block diagram illustrating details of a tour server in accordance with some embodiments.

FIG. 3 is a block diagram illustrating details of a user device in accordance with some embodiments.

FIG. 4 is a flow chart illustrating providing a tour in accordance with some embodiments.

FIG. 5 is a flow chart illustrating receiving a tour in accordance with some embodiments.

FIG. 6 is a block diagram illustrating details of a digital device in accordance with some embodiments.

### DETAILED DESCRIPTION

The following description is provided to enable any person skilled in the art to make and use the invention(s) described. Various modifications to the embodiments are possible, and the generic principles defined herein may be applied to these and other embodiments and applications without departing from the spirit and scope of the disclosure. Thus, embodiments are not intended to be limited to the embodiments and applications shown, but is to be accorded the widest scope consistent with the principles, features and teachings disclosed herein.

People often desire to engage in multiple activities (e.g., activity types) but are unaware of available options. In one example, a person may want to go out to eat Mexican food and attend a movie, however, the person may be unaware of the Mexican food options in their neighborhood and be unaware of the location of available movie theaters.

In various embodiments, the person may input their interests (including the activity types of which the person may be interested) into a smartphone or similar device to be provided to a service (e.g., via a website) in order to receive an automatically generated tour based on their interests. A tour includes at least one place (e.g., facility) associated with each activity as well as directions on how to get from one place to the next. Each place may be automatically selected from a database based on the inputted interests, user preferences, proximity from one facility to the next, available time, critical reviews, other people's ratings of the different places, and the like.

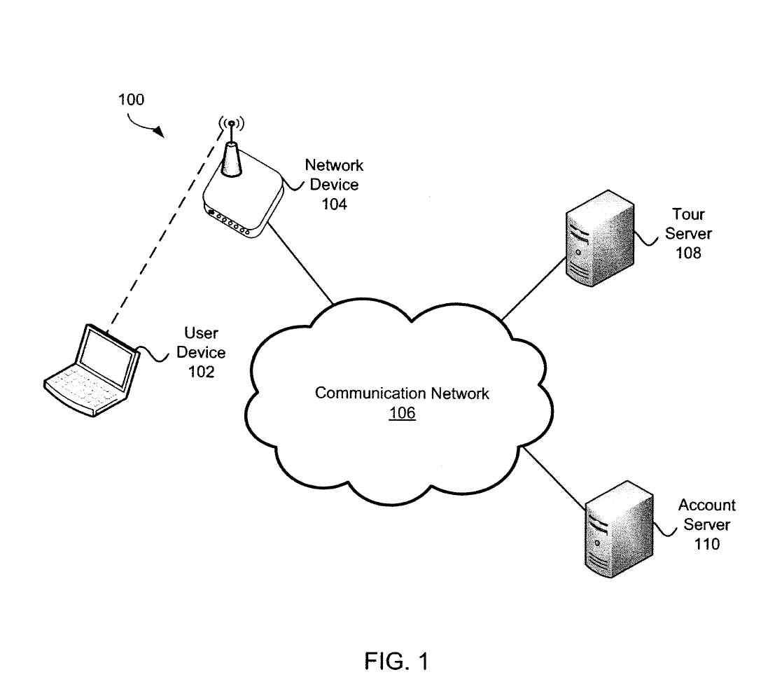

FIG. 1 is a block diagram of a network 100 in accordance with some embodiments of the present invention. The network 100 comprises a user device 102 configured to wirelessly communicate via the access point 104 with the tour server 108 over the communication network 106. Optionally, in some embodiments, an account server 110 is communicatively coupled to the local area network 106.

The user device 102 may comprise any device with a processor and memory. In some examples, the user device 102 is a digital device such as a smart phone (e.g., Apple's iPhone), personal digital assistant (PDA), laptop, or other network-capable device to receive a tour including events and activities of interest to the user.

The network device 104 may comprise an access point which allows the user device 102 to wirelessly communicate with the tour server 108. In one example, the network device 104 is a hotspot available at a local coffee shop that the user accesses in conjunction with a wireless device such as a laptop. In another example, the user's user device 102 comprises a cellular phone from which the user accesses the tour server 108 on the Internet through a network device 104 associated with a cellular network (e.g., AT&T's 3G network). In some embodiments, the network device 104 is optional or allows the user device 102 to communicate with the tour server 108 over a cable or telephone service.

The communication network 106 may comprise any network or combination of networks that are communicatively coupled. In one example, the communication network 106 is the Internet. In another example, the communication network 106 is a local area network or a wide area network.

The tour server 108 is any server capable of receiving a tour request and providing a tour to the user device 102. A tour request is a request from the user for a tour. The tour request may comprise a location of the user, a first activity type, and a second activity type. An activity type is a type of activity (such as an event) that may include but is not limited to, a type of food, theater productions, movies, festivals, contests, social functions, election polling places, sporting events, community events, concerts, music, museums, arboretums, garden shows, zoos, auctions, yard sales, estate sales, and open houses.

The user may also include location information within the tour request. Location information may include, but is not limited to, a current location of the user, the location where the user will be, or a location where there is one or more facilities related to the activity type(s). A facility is any place, business, or location in which an activity type occurs, takes place, or exists. In one example, an activity type is a play and the facility is a specific theater. In another example, an activity type is a festival and a facility is a main street that is holding (or will hold) a wine and art festival.

The account server 110 is a server with access to one or more user accounts. In one example, prior to sending a tour request, the user may access the account server 110 via the communication network 106 and establish a personal account. The personal account may require information from a user such as a username and password. The personal account may store tour information regarding past, current, or future tours of the users, the user's ratings of different facilities, user interests, and/or user preferences.

In various embodiments, the account server 110 may store information regarding the user in a knowledge database. The knowledge database may include, but is not limited to, user information including tour information, facility selection, past activity types included in tour requests, and any personal information regarding the user. The knowledge base may be used to help the tour server 108 choose appropriate facilities related to one or more activity types.

Those skilled in the art will appreciate that the activity type is not limited to food options and entertainment. In one example, a user may provide a tour request comprising activity types associated with errands such as, but not limited to, a grocery store, dry cleaning, home repair stores, and the like. In response, the user may receive a list of available facilities for performing each task as well as directions between each facility that is optimized for time, distance, and/or user preference.

Those skilled in the art will also appreciate that the user may include a selection of one or more facilities as well as one or more activity types in the tour request. In one example, the user wishes to eat at a specific restaurant and then attend a jazz performance proximate to the restaurant. The tour server 108 may select one or more facilities associated with jazz performances proximate to the restaurant and provide to the user a tour including directions between the restaurant and at least one facility associated with the jazz performance.

Although two servers are depicted as being coupled with the local area network 106, there may be any number of servers coupled to the local area network 106. In one example, a single server may perform the functions of the tour server 108 and the account server 110.

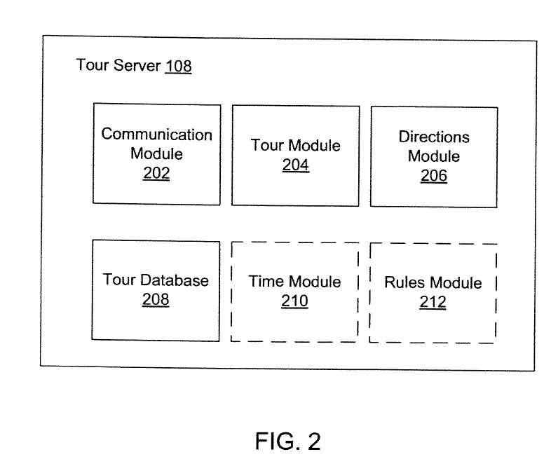

FIG. 2 is a block diagram illustrating details of a tour server 108 in accordance with some embodiments. The tour server 108 comprises a communication module 202, a tour module 204, a directions module 206, a tour database 208, an optional time module 210, and an optional rules module 212. The communication module 202 is configured to communicate over the communication network 106 with one or more user devices 102. In various embodiments, the communication module 202 of the tour server 108 is configured to receive a tour request from the user device 102 and to provide a tour as well as directions between different facilities associated with different activity types.

In one example, the communication module 202 may provide a web page which is configured to receive input from the user via the user device 102. The web page may have fields in which the user can type location information, a first activity type, and a second activity type, for example. In another example, the web page may have one or more pull down menus in which the user may select desired activity types. Alternately, in another example, the communication module 202 may not provide a web page but be configured to receive a tour request directly from the user device 102 (e.g., via client software installed on the user device 102) and/or from a website located on another server communicatively coupled to the communication network 106.

The communication module 202 may also provide the tour to the user device 102 via the website or directly to the user device 102. In one example, the user device 102 comprises a smartphone which includes an application. The application may be configured to receive information related to a tour request from the user, provide the tour request to the tour server 108 via the communication network 106, receive the tour from the communication module 202, and display the tour to the user.

The tour module 204 is configured to receive at least some information regarding the tour request from the communication module 202 and generate a tour based on at the information. In one example, the tour module 206 receives a first activity type from the tour request provided to the communication module 202. The tour module 206 may then access a tour database 208 to find available facilities associated with the first activity type. The tour module 206 may also receive a second activity type form the tour request and access the tour database 208 to find available facilities associated with the second activity type.

The selection of one or more facilities from the tour database 208 may be based on the activity type(s) from the user request as well as user criteria. The user's criteria may include user preferences, rules, or predetermined default options that influence the selection of facilities. In one example, the user may input the user criteria as a part of the tour request. Alternately, the user may specify the user criteria as a part of the user's user preferences that may be stored within a user account (e.g., via the account server 110).

In another example, the user criteria may be predetermined as a default option that the user may override. In one example, the user may be located in downtown San Francisco and inputs an activity type that comprises fine dining in the tour request. The tour module 204 may access the tour database 208 to find fine dining restaurants (i.e., a facility associated with the activity type) limited by the user criteria. In one example, the user criteria may limit the selection of fine dining restaurants to those that are within two miles of the user's present location (e.g., as determined by the location information contained in the tour request).

Those skilled in the art will appreciate that the user criteria may change depending upon the activity type. In one example, the activity type may include wine tasting in Napa Valley, Calif. In this example, the user criteria would not limit the user to within two miles of the user's present location if the user is presently located in San Francisco, rather, the user criteria may limited the selections from available facilities to include vineyards that are within five miles of each other.

In various embodiments, user criteria may be grouped based on the activity type, location, and/or time of activity. In one example, a first user criteria may be used for all users looking for immediate local entertainment options (e.g., food, movies, and jazz music). The first criteria may limit the facilities to those locally accessible to the current user's position and to those facilities that are close to each other (e.g., the selected restaurant is within walking distance to the jazz music hall). A second criteria may be used for users looking for activities that are to occur in a separate location such as a weekend in San Diego, Calif. A third criteria may be used for users looking for activities to be performed at another time. Those skilled in the art will appreciate that user criteria may be predetermined for any number of activity types, facilities, locations, and times.

The directions module 206 is configured to receive two or more facilities from the tour module 204 and determine distance and/or directions between the two or more facilities. In one example, the tour module 204 retrieves two facilities associated with two separate activity types from the tour database 208. The tour module 204 may also retrieve an address for each facility (e.g., from the tour database 208 or from a website associated with each facility). The directions module 206 may then determine the distance between the facilities and provide the distance to the tour module 204. In some embodiments, the directions module 206 determines the directions between two or more facilities and provides the directions to the tour module 204 and/or the communication module 202.

In various embodiments, the directions module 206 may determine the directions and/or proximity of the user and one or more facilities retrieved by the tour module 204. In one example, the directions module 206 receives location information from the tour request. The location information may include where the user presently is located or where the user will be located. The directions module 206 may determine the distance between the user location and one or more facilities.

The tour database 208 comprises information associated with different activity types including, but not limited to, facility name, facility addresses, facility contact information (e.g., phone number), facility web site address, facility email address, facility information, review information and/or rating information. Facility information may include descriptions of the facility and services offered. Review information may include critical reviews, public reviews (e.g., magazine reviews, newspaper reviews, and blog reviews), user reviews, or reviews by other users, for example. Rating information may include ratings provided by critics, public ratings (e.g., magazine ratings, newspaper ratings, and blog ratings), user ratings, or ratings by other users. Although the tour database 208 is described as a database, the tour database may comprise any kind of data structure or combination of data structures.

In some embodiments, the tour database 208 comprises information associated with products and services provided by, at, or around one or more facilities. In one example, information regarding a business, product, or service is input by users or others into the tour database 208. In another example, information regarding the business, product, or service may be retrieved from a website or server.

Further, in some embodiments, the tour database 208 may also contained tours taken by other people which may be provided to user searching for tours taken by others. Previously stored tours may be modified by the user. Further, the tour database 208 may contain information regarding the tastes and preferences of people who have taken similar tours or enjoyed similar experiences. The tour module 204 may use that information in making selections of facilities related to activity types or provide suggestions to the user.

The optional time module 210 is configured to estimate time available for different parts of the tour. In some embodiments, the tour request includes a start time for the tour. The time module 210 may estimate the time required for the first activity and the second activity as well as the time required for the user to travel between the two facilities based on directions form the directions module 206.

In various embodiments, the time module 210 uses an algorithm that weights different variables that affect time estimation. In one example, the time module 210 may have a default expected time to eat at a restaurant. The default time may be different for restaurants in different cities or restaurants located in busier parts of town. Further, the default time may be adjusted by user preference (e.g., the user prefers to spend at least an hour or longer during dining), past experiences by the user stored in user preferences, past experiences by other users, time of day, proximity to an event (e.g., baseball game or concert), and/or estimation required for that facility (e.g., waiting time for this particular facility is ½ hour).

In some embodiments, the time module 210 may assume that the start time for a tour request, unless stated otherwise, is the current time. As the user visits the different facilities, the user may alert the tour server 108 of the time. The time module 210 may then make recommendations or suggest changes to the tour based on available time remaining or new information (e.g., an accident on the highway affecting travel time or inclement weather).

In some embodiments, the optional rules module 212 stores and maintains rules. The tour module 204 may select one or more facilities associated with an activity type based on rules from the rules module 212. Rules may comprise user criteria, user preferences, and rules received from the current or past tour requests. Rules may require available time, proximity of facilities to the user, and the like. In one example, the rules module 212 allows the tour module 204 to select one facility over another and/or sort facilities.

One or more rules may be override others based on user choice. In one example, the user may choose that user preferences stored in the user account override all other conflicting rules, including any user criteria selected by default. In another example, the user may choose to allow any user criteria contained within a tour request override any conflicting rules contained in the user preferences.

Further, the user may choose the order in which rules may be applied. In one example, the user may choose to apply any default criteria first, followed by rules from the user preferences, and finally by rules provided in the tour request. For example, a user may select an activity type of fine dining in a tour request. The tour module 204 may retrieve a list of available facilities associated with the activity type. A number of facilities may be removed from the list based on a default user criteria that removes any facilities that are more than ten miles from the user's current location. Several more facilities may be removed from the list based on a user preference for French fine dining. Further, the tour request may require that the fine dining activity type be within walking distance of the user's current location, and, therefore, facilities are removed from the list that are beyond walking distance. The remaining facilities, if there is more than one remaining facility, may be sorted based on distance, rating, or review. One or more of the remaining facilities may then be provided to the user.

In some embodiments, the tour module 204 generates a tour based, in part, on time estimates provided by the time module 210. In one example, the tour module 204 determines that there is not enough time in an evening to perform all of the activities in the activity request. In response, for example, the tour module 204 may provide an alert to the user, reorganize the tour to minimize travel time, or omit certain activities/facilities from the tour.

In one example, the tour request indicates that the user, located in San Francisco, wishes to go wine tasting in Napa County and surrounded regions for a day on an upcoming weekend. The user request may indicate a start time. The tour module 204 may select facilities (wineries) in Napa County and the surrounded regions to form a wine tour. The selection of wineries may be based on user preference (e.g., old world style wines) retrieved from the user account, on proximity of the first vineyard in the target region to the user's starting location, when the first winery is open (e.g., by the tour module 204 retrieving hours of operation from the tour database 208), proximity of the next winery to the previous winery, and so on. The tour module 204 may receive an end time from the tour request or assume a default end time when all wineries in the area are closed. In some embodiments, the tour module 204 generates a tour which includes the names of the selected facilities, directions between facilities, the time estimated for travel between each pair of facilities, and the time estimated that the user will spend at each facility.

Those skilled in the art will appreciate that the tour server 108 may comprise any number of modules. In one example, there may be fewer modules than those depicted in FIG. 2 which may perform the same functions and/or more functions as those described herein. In another example, there are more modules than those depicted in FIG. 2.

A module may comprise software, hardware, or a combination of both. Software comprises computer readable instructions able to be read and executed by a processor. The instructions may be contained within a computer readable media or medium which is described herein. Hardware may comprise logic, circuits, and/or firmware.

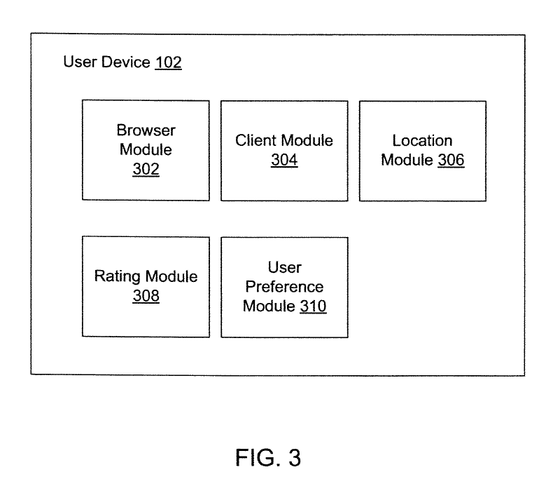

FIG. 3 is a block diagram illustrating details of a user device 102 in accordance with some embodiments. The user device 102 comprises a browser module 302, a client module 304, a location module 306, a rating module 308, and a user preference module 310. The browser module 302 provides an interface through which a user may communicate with the tour server 108. In some embodiments, the browser module 302 provides an Internet browser (e.g., Internet Explorer, Mozilla Firefox, or Google Chrome) which allows the user to interact with a web page from the tour server 108 to provide a tour request. 100591 The optional client module 304 is an application configured to communicate with the tour server 108. In some embodiments, the user must install the client module 304 on the user device 102 prior to providing a tour request. In one example, once the client module 304 is installed, the user may activate the module. Once activated, the client module 304 may allow the user to communicate with the tour server 108. In one example, the client module 304 provides a secure communication with the tour server 108 via encryption such as SSL or secure http. In some embodiments, the client module 304 is a browser based application that works in conjunction with the browser module 302. In other embodiments, the client module 304 is an application that stands apart from the browser module 302.

The location module 306 provides location information of the user device 102 and/or the user. In some embodiments, the location module 306 comprises a global positioning system (GPS) which automatically determines the location of the user device 102. The location module 306 may provide location information (e.g., latitude and longitude coordinates) to the client module 304 which, in turn, may include the location information within a tour request.

The rating module 308 allows the user to rate or review different facilities (e.g., restaurants, theaters, plays, and the like) and/or tours. In one example, a user may provide a tour request to the tour server 108 and receive a tour. The user may rank the quality of the tour and express likes and dislikes about the tour. The tour may be selected by other users based on the user's review and/or rankings. Further, the user may review and/or rank one or more facilities on the tour. The reviews and/or rankings may be saved as a part of the user's user preferences and, in some embodiments, saved as a part of the tour database 208 to provide further information to the tour module 204 to be used in facility selection.

The user preference module 310 is configured to store user preferences associated with tours and/or facilities. In some embodiments, the user may configure the user preference module 310 to store preferences for tours including, for example, maximum distance from the user to a facility, expected time at one or more activity types, facilities that do not require a car to get to, no Mexican food, preference for Indian food, preference for 18^{th} century art, no modern art, etc. One or more of these user preferences may be stored in the account server 110. The user preference module 310 may also store preferences that influence the look and operation of the browser module 302 (e.g., color, sound, and appearance) and/or the client module 304.

Those skilled in the art will appreciate that the user device 102 may comprise any number of modules. In one example, there may be fewer modules than those depicted in FIG. 3 which may perform the same functions and/or more functions as those described herein. In another example, there are more modules than those depicted in FIG. 3.

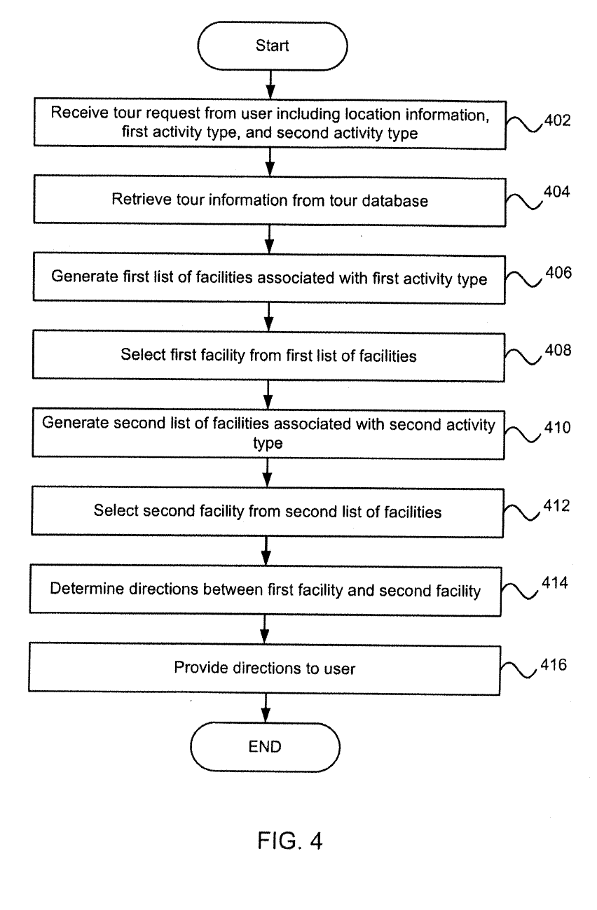

FIG. 4 is a flow chart illustrating providing a tour in accordance with some embodiments. In step 402, the tour server 108 receives a tour request from the user device 102. The tour request comprises location information, a first activity type, and a second activity type. The location information identifies where the user wishes to begin the tour. The first activity type and the second activity type are two different types of activities the user wishes to engage in. In this example, unless specified otherwise by the tour request, the tour server 108 assumes that the start time for the tour is the current time. The end time of the tour may be when all available facilities associated with either type of activity are closed.

Although there are only two activity types specified in the tour request discussed in FIG. 4, those skilled in the art will appreciate that there may be any number of activity types within a tour request. Further, although the activity types are identified as a “first activity type” and a “second activity type,” the tour server 108 may generate a tour which direct activities beginning with facilities associated with either activity type. In one example, the facility associated with the second activity type may be closer to the user when the user makes a tour request and, as a result, the facility associated with the second activity type is identified as the first destination of the tour. In some embodiments, the user designates some or all of the order of facilities of the tour in the tour request or user preferences. In one example, the tour server 108 may order an activity type directed at food based on an indication from the user, even if the facility for that food type is farther away than other points of interest which the user may later visit on the tour. Further, the tour server 108 may have a predetermined criteria that, unless directed otherwise, places activity types directed at food during breakfast, lunch, and dinner hours.

In step 404, the tour module 204 retrieves tour information from the tour database 208. Tour information may comprise any information regarding the activity types or facilities associated with activity types. In one example, tour information includes the name of a facility associated with the first activity type, address, contact information, web site address, hours of operation, reviews, ratings, and information describing the facility or products and services offered at or around the facility.

In step 406, the tour module 204 generates a list of facilities associated with the first activity type. In some embodiments, the tour module 204 retrieves a list of available facilities associated with the first activity type from the tour database 208 based on predetermined user criteria. In one example, facilities that are too far away from the user's location information may not be included in the list. In another example, facilities that are consistently rated low by the user or the users may also not be included in the list.

In step 408, the tour module 204 selects at least one first facility from the first list of facilities. In various embodiments, the tour module 204 sorts the list of facilities generated in the previous steps based on user preference, proximity to other points of interests (e.g., facilities that will be later visited), proximity to the user's current position, rating by the user, or rating of others, for example. All this information and more may be taken into account and weighted in comparing different facilities in the list in order to sort the list and/or make the selection.

In step 410, the tour module 204 generates a list of facilities associated with the second activity type and, in step 412, the tour module 204 selects a second facility from second list of facilities. In various embodiments, the tour module 204 determines which activity type should occur first based on predetermined user criteria such as closest facilities to the user, user preferences, or information contained in the tour request (e.g., via the rules module 212). Once the activity types are placed in order by the tour module 204, then the a list of facilities for the activity type that is to occur first is generated and/or a facility associated with the activity type that is to occur first is selected. When the second list of facilities for the next activity type is generated, those that are too far from the initial facility may be removed from the list based on a predetermined criteria or user preference, for example.

In step 414, the tour module 204 and/or the directions module 206 determines directions between the first facility and the second facility. In various embodiments, one or more facilities may be removed from a list of facilities based on lack of proximity to the previous facility. Further, the selection of one of more facilities (such as step 412) may be based, in part, on proximity and accessibility to the previous facility associated with a previous activity type.

In step 416, the tour module 204 may provide the directions to the user. In various embodiments, the tour module 204 provides a list of different facilities, each of the facilities associated with a different activity type. In one example, the facility at the top of the list is to be visited first, then the second facility, and so forth. Directions from each facility to the next facility are provided. In some embodiments, directions from the user to the first facility are provided.

Further, a map including one or more of the facilities is included. The map may include an icon identifying the user's current location. The map may be updated as the user moves based on the location module 306 of the user device 102.

The tour module 204 may provide tour information to the user as well. In one example, reviews, ratings, and descriptions of one or more facilities is provided to the user. In some embodiments, links to reviews and ratings may be provided to the user.

In various embodiments, the tour module 204 may base the generation of the list of available facilities, removing facilities from the list, sorting the list, and/or selection from the list on rules from the rules module 212 and information contained in the user knowledgebase associated with the account server 110. In one example, the tour module 204 may select a facility based on the user's past behavior or preferences stored within the user knowledgebase.

Further, the tour module 204 may base the generation of the list of available facilities, removing facilities from the list, sorting the list, and/or selection from the list on other user experiences. In one example, the user may identify one or more other users as having similar interests and preferences (e.g., based on the other users' reviews, ratings, and tours taken). Those other users having similar interests and preferences may be identified in the user preferences. The tour module 204 may then make decisions, based in part, on the experiences of those preferred users.

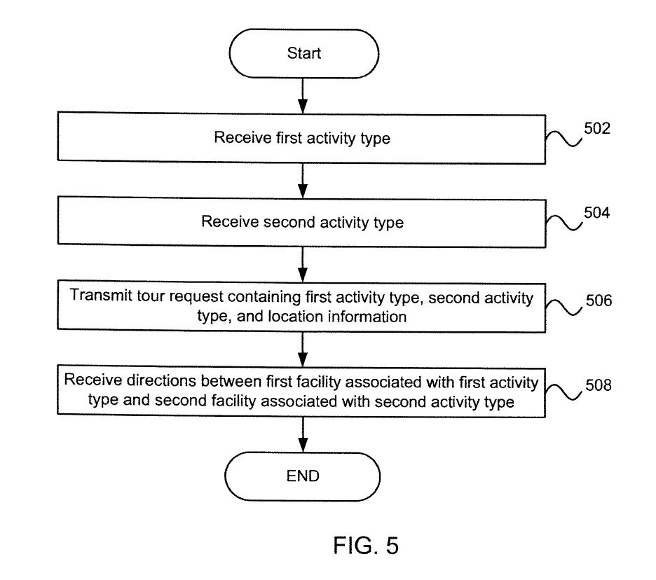

FIG. 5 is a flow chart illustrating receiving a tour in accordance with some embodiments. The user may bring establish communication between the user device 102 (e.g., laptop) and the tour server 108 over the communication network 106. In step 502, the browser module 302 receives the first activity type from the user and in step 504, the browser module 302 receives the second activity type from the user. In some embodiments, the user enters the activity type into a field or otherwise selects from predetermined options through the browser module 302. The user may also include a start time for the tour if the start time is not the time that the tour request is generated and/or an end time when the tour is expected to end.

In step 506, the browser module 302 transmits a tour request containing the first activity type, the second activity type, and location information to the tour server 108. In some embodiments, the browser module 302 retrieves current location information of the user device 102 from a GPS unit via the location module 306. The tour request may also include user preferences (e.g., all facilities are to be within walking distance of the current location and food related activities are to be less than $40 per person) from the user preference module 310.

In step 508, the browser module 302 receives the directions between a first facility associated with the first activity type and a second facility associated with the second activity type. In some embodiments, the browser module 508 receives and displays a tour identifying different facilities for each activity type previously identified. The browser module 508 may receive and display directions for the user to the first facility, directions from the first facility to the second and so forth. The browser module 508 may also receive and display estimated time for travel and estimated time for each activity.

In some embodiments, the browser module 508 may receive a list of two more facilities for an activity type for the user to select from. Each facility may meet all rules including criteria and/or user preferences. In some embodiments, the user may include a user preference to select from a limited number of facilities for one or more activity types. Directions may be provided between each facility of the activity type to a different facility of another activity type. Alternately, directions may be determined between facilities once the user makes a selection.

Further, in various embodiments, the user may receive the tour and facilities selection from the tour server 108 and indicate that at least one facility is not acceptable or otherwise desired. The browser module 508 may transmit that information to the tour server 108 which may then select another facility for that activity type. The new selection may be displayed to the user who may accept the new selection or request another.

Although the tour module 204 is discussed as selecting facilities based on a number of factors, those skilled in the art will appreciate that, in some embodiments, the user may select each facility. In one example, the communication module 202 may provide the user with a directory of various activity types (e.g., food types, festivals, activities, and so on). The user may choose the first activity type as food types. The communication module 202 may then provide a selection of restaurants that are associated with that food type as well as information regarding that restaurant, available reviews, ratings, addresses, location, and/or maps. The user may then select a restaurant and then proceed to make another selection of activity type. After the user has completed selected different facilities for different activity types, the tour module 204 may generate a tour with relevant information (e.g., addresses), directions from the user to the first facility and directions between facilities from the directions module 206, a map, and time estimates for each activity and travel form the time module 210.

In some embodiments, the tour server 108 provides one or more predetermined tours that the user may select. In one example, the tour server 108 displays a list of different predetermined tours based on the user device 102 location or the location that the user will be. The tour server 108 may provide information regarding the predetermined tour including estimated times, directions between facilities on the tour, reviews of facilities, reviews of the tour itself, rating of the tour itself, and so on. For example, the tour server 108 may provide to the user of Chicago, Ill., a list including a walking tour of historic architecture in Chicago and tour based on local best places to eat and art museums. The tours themselves may be reviewed and or rated by the user or other users.

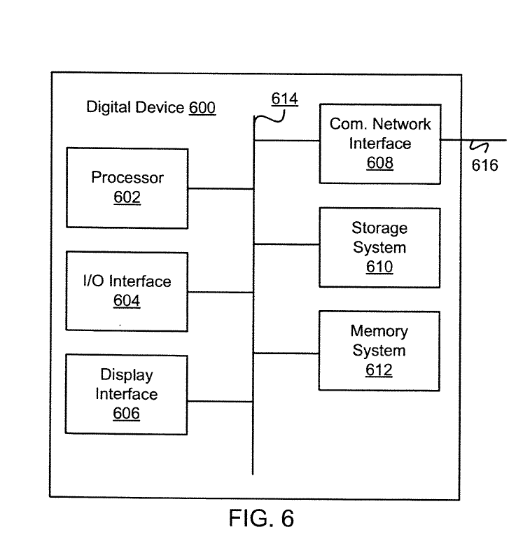

FIG. 6 is a block diagram illustrating details of a digital device 600 such as a user device 102 in some embodiments. The digital device 600 includes a processor 602, such as an Intel Pentium® microprocessor. In various embodiments, the processor 602 may comprise any number of cores, processors, and/or subprocessors. The digital device 600 further includes an I/O interface 604 configured to receive input from an input device such as a keyboard or mouse, a display interface 606 configured to be operatively coupled with a display such as a cathode ray tube display, a communications network interface 616, a data storage system 610 such as a magnetic disk, and a memory system 612 such as Random-Access Memory (RAM), each coupled to the communications channel 614. The communications network interface 608 may be coupled to a network such as the wide-area network commonly referred to as the Internet over the network link 616. In some embodiments, the network link 616 allows for wireless communication with a network. One skilled in the art will recognize that, although the data storage system 610 and memory system 6 12 are illustrated as different units, the data storage system 610 and memory system 612 can be parts of the same unit, distributed units, virtual memory, etc.

Computer readable media comprises any media that may store computer readable instructions (e.g., computer programs) that may be executed by a processor. In various embodiments, the data storage system 610 and the memory system 612 comprise computer readable media. The data storage system 610 and/or memory system 612 may store an operating system such as the Microsoft Windows XP, Linux, the IBM OS/2 operating system, the MAC OS, or UNIX operating system and/or other programs. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the digital device 600 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader such as a magnetic disk drive, hard disk drive, magneto-optical reader, etc. may be coupled to the communications bus 614 for reading a computer-readable storage medium (CRSM) such as a magnetic disk, a hard disk, a magneto-optical disk, RAM, etc. Accordingly, the digital device 600 may receive programs and/or data via the CRSM reader. Further, it will be appreciated that the term “memory” herein is intended to cover all data storage media whether permanent or temporary.

The foregoing description of the embodiments is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The embodiments is limited only by the following claims.

1. A method comprising:
receiving a tour request comprising location information, a first activity type, and a second activity type from a user;
retrieving tour information from a tour database based on the location information, the first activity type, and the second activity type, the tour information comprising a first facility associated with the first activity type and a second facility associated with the second activity type;
determining directions between the first facility and the second facility; and
providing the directions to the user.

2. The method of claim 1, wherein the first activity type comprises a food type, the second activity type comprises a theatrical production, the location information comprises the location of the user, the tour information comprises a name of a restaurant associated with the food type and a theater associated with the theatrical event, and the directions are between the restaurant and the theater.

3. The method of claim 1, wherein the directions further comprise directions from the user to the first facility.

4. The method of claim 1, further comprising generating a map showing a first location of the first facility and a second location of the second facility.

5. The method of claim 1, wherein retrieving tour information further comprises:
retrieving user preferences from a user account associated with the user;
retrieving a list of facilities associated with the first activity type; and
selecting at least one first facility from the list of facilities based on the user preferences.

6. The method of claim 1, wherein retrieving tour information further comprises:
retrieving a list of facilities associated with the first activity type;
retrieving at least one review of at least one first facility of the list of facilities; and
selecting at least one first facility from the list of facilities based on the at least one review.

7. The method of claim 6, further comprising sorting the list of facilities based on the at least one review.

8. The method of claim 7, wherein providing the directions to the user comprises providing at least some of the sorted list of facilities including the selected at least one first facility to the user.

9. The method of claim 1, wherein retrieving tour information further comprises:
retrieving a list of facilities associated with the first activity type;
determining a first distance between the user and a first facility of the list of facilities and a second distance between the user and a second facility of the list of facilities;
determining a shortest distance based on a comparison of the first distance to the second distance; and
selecting at least one facility from the list of facilities based on the shortest distance.

10. The method of claim 1, wherein retrieving tour information further comprises:
retrieving a first list of facilities associated with the first activity type;
selecting a first facility from the first list of facilities;
retrieving a second list of facilities associated with the second activity type;
determining a distance between the first facility and at least one second facility from the second list of facilities; and
selecting the second facility from the second list of facilities based on the distance determination.

11. A system comprising:
a tour module configured to retrieve tour information from a tour database based on location information, a first activity type, and a second activity type, the tour information comprising a first facility associated with the first activity type and a second facility associated with the second activity type;
a direction module configured to determine directions between the first facility and the second facility; and
a communication module configured to receive a tour request comprising the location information, the first activity type, and the second activity type from a user and to provide the directions to the user.

12. The system of claim 11, wherein the first activity type comprises a food type, the second activity type comprises a theatrical production, the location information comprises the location of the user, the tour information comprises a name of a restaurant associated with the food type and a theater associated with the theatrical event, and the directions are between the restaurant and the theater.

13. The system of claim 11, wherein the directions further comprise directions from the user to the first facility.

14. The system of claim 11, further comprising a map module configured to generate a map showing a first location of the first facility and a second location of the second facility.

15. The system of claim 11, wherein retrieving tour information further comprises:
a user preference module configured to retrieve user preferences from a user account associated with the user; and
a facility selection module configured to retrieve a list of facilities associated with the first activity type and select at least one first facility from the list of facilities based on the user preferences.

16. The system of claim 1, wherein the tour module is further configured to retrieve a list of facilities associated with the first activity type, to retrieve at least one review of at least one first facility of the list of facilities and to select at least one first facility from the list of facilities based on the at least one review.

17. The system of claim 16, wherein the tour module is further configured to sort the list of facilities based on the at least one review.

18. The system of claim 17, wherein the communication module configured to provide the directions comprises the communication module configured to provide at least some of the sorted list of facilities including the selected at least one first facility to the user.

19. The system of claim 11, wherein the tour module further configured to retrieve a list of facilities associated with the first activity type and wherein the direction module is configured to determine a first distance between the user and a first facility of the list of facilities and a second distance between the user and a second facility of the list of facilities.

20. The system of claim 19, wherein the tour module is further configured to determine a shortest distance based on a comparison of the first distance to the second distance and to select at least one facility from the list of facilities based on the shortest distance.

21. The system of claim 11, wherein the tour module further configured to retrieve a first list of facilities associated with the first activity type, to select a first facility from the first list of facilities, retrieve a second list of facilities associated with the second activity type, and to select the second facility from the second list of facilities based on a distance determination between the first facility and at least one second facility from the second list of facilities.

22. A computer readable medium comprises instructions executable by a processor for performing a method, the method comprises:
receiving a tour request comprising location information, a first activity type, and a second activity type from a user;
retrieving tour information from a tour database based on the location information, the first activity type, and the second activity type, the tour information comprising a first facility associated with the first activity type and a second facility associated with the second activity type;
determining directions between the first facility and the second facility; and
providing the directions to the user.
